(19) United States
(12) Patent Application Publication
(10) Pub. No.: US 2024/0029141 A1
(43) Pub. Date: Jan. 25, 2024

(54) HEALTH SUPPORT SYSTEM, HEALTH SUPPORT METHOD, AND PROGRAM

(71) Applicant: TOYOTA JIDOSHA KABUSHIKI KAISHA, Aichi-ken (JP)

(72) Inventors: Issei NAKASHIMA, Katsushika-ku (JP); Toru MIYAGAWA, Seto-shi (JP); Hideo HASEGAWA, Nagoya-shi (JP); Yusuke KINOSHITA, Ota-ku (JP); Hiroki SATO, Chuo-ku (JP); Hiroaki KAMEI, Taito-ku (JP); Maika HASHIMOTO, Urayasu-shi (JP); Manabu YAMAMOTO, Toyota-shi (JP)

(21) Appl. No.: 18/357,155

(22) Filed: Jul. 24, 2023

(30) Foreign Application Priority Data
Jul. 25, 2022 (JP) 2022-117833

(51) Int. Cl. G06Q 30/0601

(52) U.S. Cl. CPC G06Q 30/0631

(57) ABSTRACT

A health support system includes a group generation unit configured to generate, based on payment data, a group including a plurality of the users as members; a data detection unit configured to detect a change in a value of a predetermined data item in the physical data of the members; a purchase history extraction unit configured to extract purchase history of a product or a service that changes the value of the predetermined data item from the payment data of the member regarding whom the change in the value of the predetermined data item has been detected; a recommendation information generation unit configured to generate recommendation information for recommending the products or services specified by the extracted purchase history; and a notification unit configured to notify the other members of the group of the generated recommendation information.

### CROSS REFERENCE TO RELATED APPLICATIONS

This application is based upon and claims the benefit of priority from Japanese patent application No. 2022-117833, filed on Jul. 25, 2022, the disclosure of which is incorporated herein in its entirety by reference.

### BACKGROUND

The present disclosure relates to a health support system, a health support method, and a program.

Systems for recommending products to users have been known. For example, Japanese Unexamined Patent Application Publication No. 2015-14887 discloses a product information providing system including a preference profile generation unit configured to generate preference profile information of a customer based on personal profile information of the customer and purchase behavior history information, a recommendation generation unit configured to generate recommendation information for the customer based on the preference profile information, and a notification unit configured to notify the customer of the recommendation information.

### SUMMARY

When a user is trying to decide whether or not to purchase a product or a service, whether or not other users have purchased this product or service may influence the purchase decision made by the user. In particular, the purchasing behaviors of users with whom the user has more in common may have a greater impact on the purchase decision made by the user than users with whom the user has nothing in common do. Further, the user expects that a product or a service to be purchased will bring about a desired effect. In the technique disclosed in Japanese Unexamined Patent Application Publication No. 2015-14887, however, it is impossible to reflect behavior of purchasing an effective product or service by users with whom the user has in common in a recommendation of the product or the service.

The present disclosure has been made in view of the aforementioned circumstances and an object of the present disclosure is to provide a health support system, a health support method, and a program capable of making purchasing of a product or a service that supports health appealing to a user more definitely.

One aspect of the present disclosure to accomplish the aforementioned object is a health support system including: a payment data acquisition unit configured to acquire payment data of a user; a group generation unit configured to generate, based on the payment data, a group including a plurality of the users as members; a member data acquisition unit configured to acquire physical data of each of the members; a data detection unit configured to detect a change in a value of a predetermined data item in the physical data; a purchase history extraction unit configured to extract purchase history of a product or a service that changes the value of the predetermined data item from the payment data of the member regarding whom the change in the value of the predetermined data item has been detected; a recommendation information generation unit configured to generate recommendation information for recommending the products or services specified by the extracted purchase history; and a notification unit configured to notify the other members of the group of the generated recommendation information.

According to the above health support system, a user is able to acquire information regarding effective products or services used by other users regarding whom the user feels a sense of familiarity due to the user belonging to the group including the other users. Therefore, it is possible to make purchasing of a product or a service that supports health appealing to a user more definitely.

In the above aspect, the recommendation information generation unit may generate the recommendation information including an amount of change in the value of the predetermined data item.

According to the above configuration, it is possible to notify the other users of information indicating how much of an effect the product or the service to be recommended had on the user who has used the product or the service to be recommended, whereby the other users are able to obtain information that will help them to make a decision whether or not to purchase the product or the service.

In the above aspect, the recommendation information generation unit may generate the recommendation information including a purchase frequency or a purchase volume by the member regarding whom the change in the value of the predetermined data item has been detected regarding the products specified by the extracted purchase history.

According to the above configuration, it is possible to notify other members of information indicating how frequently or how many products the user who has used the product to be recommended has purchased, whereby the other members are able to obtain information that will help them to make a decision whether or not to purchase the product.

In the above aspect, the recommendation information generation unit may generate the recommendation information including a usage frequency by or a usage period of the member regarding whom the change in the value of the predetermined data item has been detected regarding the services specified by the extracted purchase history.

According to the above configuration, it is possible to notify other members of information indicating how frequently or how long the user who has used a service to be recommended has used this service, whereby the other members are able to obtain information that will help them to make a decision whether or not to purchase the service.

In the above aspect, the recommendation information generation unit may generate the recommendation information further including information for recommending products or services related to the products or the services specified by the extracted purchase history.

According to the above configuration, not only information on the product or the service that the user has actually purchased but also information on products or services related to the product or the service that the user has actually purchased are sent to other users, which help the other users to make a decision whether or not to buy various related products or services.

In the above aspect, the member data acquisition unit may further acquire data of an exercise history of each of the members, and the recommendation information generation unit may generate the recommendation information for recommending, among the products or the services specified by the extracted purchase history, the product or the service selected based on the exercise history of the member regarding whom the change in the value of the predetermined data item has been detected.

According to the above configuration, it is possible to recommend a product or a service that has had an effect on a user more accurately.

Another aspect of the present disclosure to accomplish the aforementioned object is a health support method including: acquiring payment data of a user; generating, based on the payment data, a group including a plurality of the users as members; acquiring physical data of each of the members; detecting a change in a value of a predetermined data item in the physical data; extracting purchase history of a product or a service that changes the value of the predetermined data item from the payment data of the member regarding whom the change in the value of the predetermined data item has been detected; generating recommendation information for recommending the products or services specified by the extracted purchase history; and notifying the other members of the group of the generated recommendation information.

According to the above health support method, the user is able to acquire information regarding effective products or services used by other users regarding whom the user feels a sense of familiarity due to the user belonging to the group including the other users. Therefore, it is possible to make purchasing of a product or a service that supports health appealing to a user more definitely.

Another aspect of the present disclosure to accomplish the aforementioned object is a program for causing a computer to execute the following processing of: acquiring payment data of a user; generating, based on the payment data, a group including a plurality of the users as members; acquiring physical data of each of the members; detecting a change in a value of a predetermined data item in the physical data; extracting purchase history of a product or a service that changes the value of the predetermined data item from the payment data of the member regarding whom the change in the value of the predetermined data item has been detected; generating recommendation information for recommending the products or services specified by the extracted purchase history; and notifying the other members of the group of the generated recommendation information.

According to the aforementioned program, the user is able to acquire information regarding effective products or services used by other users regarding whom the user feels a sense of familiarity due to the user belonging to the group including the other users. Accordingly, it becomes possible to make purchasing of a product or a service that supports health appealing to a user more definitely.

According to the present disclosure, it is possible to provide a health support system, a health support method, and a program capable of making purchasing of a product or a service that supports health appealing to a user more definitely.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing one example of a configuration of a health support system according to an embodiment;

FIG. 2 is a table showing an example of payment data managed by a payment data management device;

FIG. 3 is a table showing an example of physical data managed by a health data management device;

FIG. 4 is a table showing an example of exercise data managed by the health data management device;

FIG. 5 is a block diagram showing one example of a functional configuration of a recommendation device;

FIG. 6 is a block diagram showing one example of a configuration of a computer included in each of a recommendation device, a payment data management device, a health data management device, and a user terminal device; and

FIG. 7 is a flowchart showing one example of a flow of processing of the recommendation device.

### DESCRIPTION OF EMBODIMENTS

Hereinafter, with reference to the drawings, an embodiment of the present disclosure will be described.

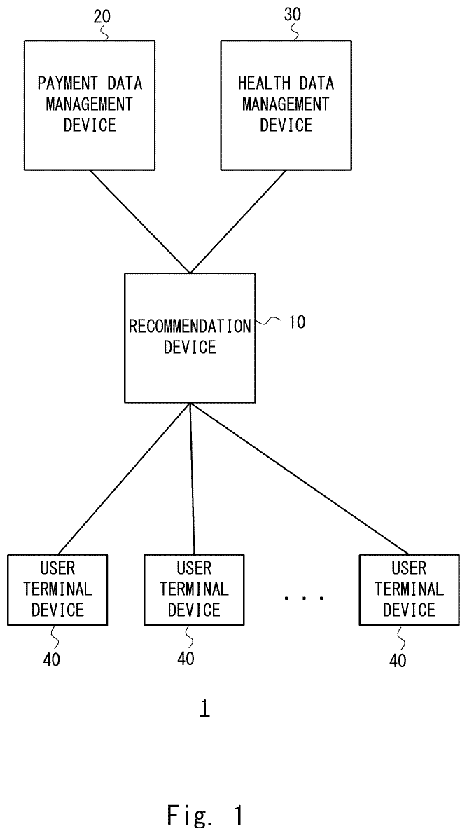

FIG. 1 is a block diagram showing one example of a configuration of a health support system 1 according to the embodiment. As shown in FIG. 1, for example, the health support system 1 includes a recommendation device 10, a payment data management device 20, a health data management device 30, and a plurality of user terminal devices 40.

The payment data management device 20 is a device that manages payment data for each user. While the payment data management device 20 manages, for example, payment data obtained by a Point Of Sales (POS) system, the payment data management device 20 may manage payment data obtained by any other technique. Further, the payment data management device 20 may receive payment data that a user has entered into a desired device such as the user terminal device 40 from this device and manage the received payment data. The payment data is data regarding payment that is caused by a user purchasing a product or a service.

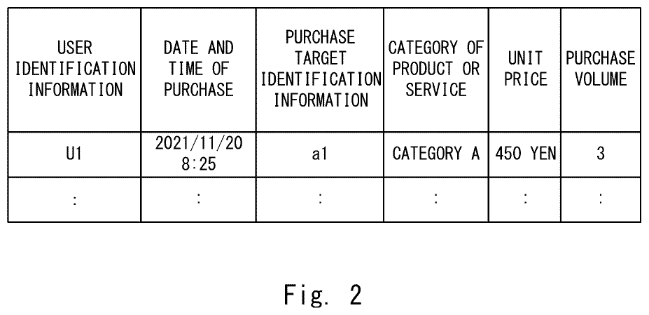

FIG. 2 is a table showing an example of the payment data managed by the payment data management device 20. As one example, as shown in FIG. 2, the payment data includes user identification information for identifying a user who has purchased a product or a service, information indicating the date and time of the purchase, purchase target identification information for identifying the product or the service that has been purchased, information indicating the category of the product or the service that has been purchased, information indicating the unit price of the product or the service that has been purchased, and information indicating the purchase volume. The payment data shown in FIG. 2 is merely one example and may include other information items or may not include some of the information items shown in FIG. 2. Further, while the information indicating the category of the product or the service is managed as the payment data in the example shown in FIG. 2, data in which the product or the service is associated with the category may be managed separately from the payment data. Further, such data may be managed by a device or the like that is not shown in FIG. 1 or may be managed by one of the payment data management device 20, the health data management device 30, and the recommendation device 10 shown in FIG. 1. In this manner, the payment data management device 20 manages payment data of various users, that is, history data of the purchasing behaviors of various users.

The health data management device 30 is a device that manages data regarding health for each user. The health data management device 30 manages at least physical data for each user as data regarding health. The physical data is data indicating measurement values regarding the user's physical state. The health data management device 30 manages physical data at a plurality of timings. The health data management device 30 may receive measurement values regarding the user's physical state measured by a wearable device worn by each user from this wearable device and manage the received measurement values, or may receive measurement values regarding the user's physical state measured by another measurement equipment from this measurement equipment and manage the received measurement values. Further, the health data management device 30 may receive physical data that the user has entered into a desired device such as the user terminal device 40 from this device and manage this received physical data.

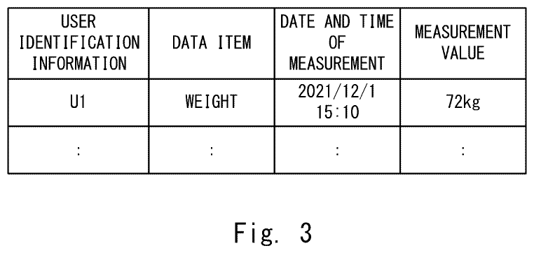

FIG. 3 is a table showing an example of the physical data managed by the health data management device 30. As one example, as shown in FIG. 3, the physical data includes user identification information for identifying a user, data items indicating items regarding which measurements are to be made, information indicating the date and time of the measurement, and information indicating the measurement values. The physical data shown in FIG. 3 is merely an example and may include other information items. The data items in the physical data may be desired items indicating the user's physical state, and may include, for example, but not limited to, weight, height, Body Mass Index (BMI), body fat percentage, blood pressure, blood test values (e.g., blood sugar level, uric acid level, hemoglobin level, serum ferritin level, or cholesterol level), muscle mass, bone mass, bone density, etc. The health data management device 30 may manage physical data regarding various data items instead of managing one type of data item.

The health data management device 30 may further manage exercise data, which is data of the user's exercise history as data regarding health for each user. The health data management device 30 may receive exercise data detected by a wearable device worn by each user from this wearable device and manage this received exercise data or may receive exercise data that the user has entered into a desired device such as the user terminal device 40 from this device and manage the received exercise data.

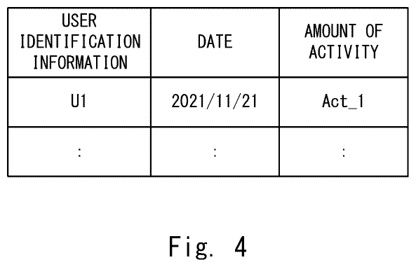

FIG. 4 is a table showing an example of the exercise data managed by the health data management device 30. As one example, as shown in FIG. 4, the exercise data includes user identification information for identifying a user, information indicating the date on which exercise has been performed, and information indicating an amount of activity. The exercise data shown in FIG. 4 is merely an example and may include other information items. The information indicating the amount of activity is information indicating how much exercise the user has performed. This information may be calories consumed by the exercise or a time during which the exercise has been performed. Further, this information may include the type of the exercise (e.g., walking, running, or swimming).

The recommendation device 10 is a device that provides recommendation information, which is information for recommending products or services, for the user. In this embodiment, the recommendation device 10 is connected to the payment data management device 20, the health data management device 30, and the user terminal device 40 in such a way that they can communicate with each other by a wire or wirelessly.

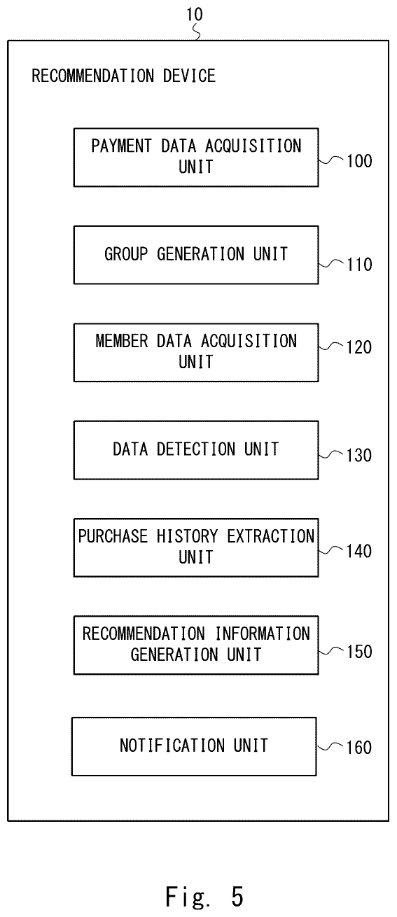

FIG. 5 is a block diagram showing one example of a functional configuration of the recommendation device 10. As shown in FIG. 5, the recommendation device 10 includes a payment data acquisition unit 100, a group generation unit 110, a member data acquisition unit 120, a data detection unit 130, a purchase history extraction unit 140, a recommendation information generation unit 150, and a notification unit 160.

The payment data acquisition unit 100 acquires payment data of users. In this embodiment, the payment data acquisition unit 100 acquires the payment data from the payment data management device 20 by requesting the payment data management device 20 for the payment data. The payment data acquisition unit 100 acquires payment data of a plurality of users.

The group generation unit 110 generates a group including a plurality of users as members based on the payment data acquired by the payment data acquisition unit 100. More specifically, the group generation unit 110 generates a group including a plurality of users as members based on the purchasing tendencies (purchasing behaviors) determined from the payment data. Specifically, the group generation unit 110 generates a group including users whose purchasing tendencies (purchasing behaviors) are similar to one another as members. That is, the group generation unit 110 generates a group based on the degree of similarity in terms of purchasing tendencies (purchasing behaviors) determined from the payment data. For example, the group generation unit 110 may group users whose rates of purchase amounts or rates of purchase volumes for each category of products or services are similar to one another into one group. Specifically, the group generation unit 110 may group users whose purchase amount (purchase volume) of products or services classified into a health category is larger than purchase amount (purchase volume) of products or services classified into an entertainment category into one group. Further, for example, the group generation unit 110 may group users whose purchase amounts or purchase volumes of specific products or services exceed a threshold into one group. Further, for example, the group generation unit 110 may group users who purchase products in similar time zones into one group. Further, for example, the group generation unit 110 may group users whose total amounts of money spent in a predetermined period (e.g., one month or one year) are similar to one another into one group. That is, the group generation unit 110 may generate a group based on a degree of similarity in terms of the amount of money spent on the purchasing of products or services during a predetermined period. The aforementioned examples are merely examples of generating a group based on the degree of similarity in terms of the purchasing tendencies (purchasing behaviors), and the group generation unit 110 may generate a group based on a degree of similarity in terms of purchasing tendencies other than the degree of similarity in terms of the aforementioned purchasing tendencies. When the group generation unit 110 generates a group, for example, the group generation unit 110 specifically generates data in which the user identification information of each member is associated with the identification information of the group. The “similarity” herein means that differences between targets to be compared are within a predetermined margin and includes a case in which there is no difference between the targets to be compared.

The member data acquisition unit 120 acquires physical data of each of the members in the group generated by the group generation unit 110. In particular, the member data acquisition unit 120 acquires physical data of each member at a plurality of timings. That is, the member data acquisition unit 120 acquires the history of the physical data of each member. In this embodiment, the member data acquisition unit 120 acquires physical data from the health data management device 30 by requesting the health data management device 30 for physical data. Note that the member data acquisition unit 120 may acquire exercise data of each of the members when the exercise data of the user is managed as well.

The data detection unit 130 detects a change in the value of a predetermined data item in physical data of each member acquired by the member data acquisition unit 120. In particular, the data detection unit 130 detects improvement of the value of the data item. The data detection unit 130 detects, for example, a change (improvement) in the value of the data item by an amount equal to or larger than a predetermined amount of change. The data detection unit 130 may detect a change (improvement) in the value of the data item by an amount equal to or larger than a predetermined amount of change in a predetermined period. The data item regarding which the change is to be detected may be any data item of the physical data. For example, the data detection unit 130 may detect a reduction in the weight, a decrease in the blood pressure, or an increase in the bone density. It is needless to say that they are merely examples of the detection made by the data detection unit 130 and detection may be performed regarding other data items.

The purchase history extraction unit 140 extracts, from payment data of a member regarding whom the change in the value of the predetermined data item has been detected by the data detection unit 130, the purchase history of a product or a service that changes (improves) the value of the predetermined data item. In particular, the purchase history extraction unit 140 extracts, from payment data regarding purchases that have been made during a period from a time when the value of the data item after it has been changed has been measured to a time traced back by a predetermined period from the time when the value of the data item after it has been changed has been measured, the purchase history of the product or the service that changes the value of this data item. Note that the time traced back by a predetermined period from the time when the value after the change has been measured may be a time when a value before the change has been measured.

The product or the service that changes (improves) the value of the predetermined data item is defined for each data item in advance. Definition information indicating this definition may specify a product or a service by identification information of the product or the service or may specify the product or the service based on the category of the product or the service. When, for example, a reduction in the weight of one member has been detected by the data detection unit 130, the purchase history extraction unit 140 refers to a predetermined list including identification information items of products or services that are expected to be effective in reducing weight and thus extracts the purchase history of products or services by this member. Alternatively, the purchase history extraction unit 140 refers to a predetermined list including categories of products or services that are expected to be effective in reducing weight and thus extracts the purchase history of products or services by this member. According to the above processing, when, for example, a reduction in the weight of one member has been detected, the purchase history extraction unit 140 extracts the purchase history such as products which fall in a diet food category purchased before there is a reduction in the weight. In this manner, the purchase history extraction unit 140 extracts the purchase history of predetermined products or services as products or services that change (improve) the value of the predetermined data item from payment data of the member regarding whom a change in the value of the predetermined data item has been detected by the data detection unit 130.

The recommendation information generation unit 150 generates recommendation information for recommending products or services specified by the purchase history extracted by the purchase history extraction unit 140. That is, the recommendation information generation unit 150 generates recommendation information for recommending products or services purchased by a member regarding whom the value of a predetermined data item has been improved. As described above, targets to be recommended by the recommendation information may either be products or services. Therefore, for example, the targets to be recommended by the recommendation information may be food, exercise tools, a meal delivery service, fitness club contracts or the like.

The recommendation information generation unit 150 may generate recommendation information regarding all the products or services specified by the purchase history extracted by the purchase history extraction unit 140 or generate recommendation information regarding some of the products or services. For example, the recommendation information generation unit 150 may set only the products whose purchase frequencies are equal to or larger than a predetermined threshold to be the targets to be recommended or may set only the products whose purchase volumes are equal to or larger than a predetermined threshold to be the targets to be recommended. Further, the recommendation information generation unit 150 may set only the services whose usage frequencies are equal to or larger than a predetermined threshold to be the targets to be recommended, or set services whose usage periods are equal to or larger than a predetermined threshold to be the targets to be recommended. Note that the recommendation information generation unit 150 may use the purchase frequency of the service as the usage frequency of the service. Further, the recommendation information generation unit 150 may specify the period during which a service is being provided by searching a database that stores information regarding services and set the specified period during which a service is being provided to be the usage period of the service.

Further, when, in particular, the member data acquisition unit 120 also acquires exercise data of members, the recommendation information generation unit 150 may select products or services to be recommended based on the exercise data. That is, the recommendation information generation unit 150 may generate recommendation information for recommending, of the products or services specified by the purchase history extracted by the purchase history extraction unit 140, products or services selected based on exercise history of a member regarding whom a change in the value of the predetermined data item has been detected (i.e., a member who has purchased this product or service). When, for example, an amount of exercise performed after a product or a service regarding exercise has been purchased has become larger than an amount of exercise performed before this product or service has been purchased by a predetermined threshold or larger, the recommendation information generation unit 150 generates recommendation information for recommending this product or service. This is because it is possible that the effect of improvement in the value of the data item is due to exercise. On the other hand, when, for example, the amount of exercise performed after the product or the service regarding exercise has been purchased has not become larger than the amount of exercise performed before this product or service has been purchased by the predetermined threshold or larger, the recommendation information generation unit 150 generates recommendation information for recommending a product or a service (e.g., product or service related to food) other than the above product or service. This is because it is possible that the effect of improvement in the value of the data item is due to a factor other than exercise. By using this recommendation information, it is possible to recommend products or services that have had an effect on a user more accurately.

In this embodiment, the recommendation information generation unit 150 generates, as the recommendation information, information indicating a product or a service to be recommended and indicating that this product or this service has been purchased by a user who belongs to a group the same as that the user who receives the recommendation information belongs to and regarding whom the value of a predetermined data item has been changed (improved). Note that this information may be character information, voice information, or an image or video. The recommendation information generation unit 150 generates, for example, a message such as “a user who tends to buy products similar to those you bought and have lost their weight have bought a product X.” as the recommendation information. In this manner, the recommendation information includes information indicating a product or a service to be recommended and information indicating that this product or this service is purchased by a user whose purchasing tendencies are similar to those of the user who receives the recommendation information and regarding whom the value of a predetermined data item has been changed.

The recommendation information may include various kinds of information. For example, the recommendation information generation unit 150 may generate recommendation information including an amount of change in the value of a predetermined data item. That is, the recommendation information may include information indicating an amount of change in the value of a predetermined data item of a member who has purchased the product or the service to be recommended. The information indicating an amount of change in the value of a predetermined data item included in the recommendation information may be an amount of change in the value detected by the data detection unit 130. By using this recommendation information, it is possible to notify the other users of information indicating how much of an effect the product or the service to be recommended had on the user who has used the product or the service to be recommended, whereby the other users are able to obtain information that will help them to make a decision whether or not to purchase the product or the service.

The recommendation information generation unit 150 may further generate recommendation information including a purchase frequency or a purchase volume by a member regarding whom a change in the value of a data item has been detected regarding products specified by the purchase history extracted by the purchase history extraction unit 140. That is, the recommendation information may include information indicating how many products to be recommended have been purchased by the member regarding whom the value of the predetermined data item has been changed. The purchase frequency and the purchase volume may be specified, for example, from the payment data of the member. By using the recommendation information, it is possible to notify other members of information indicating how frequently and how many times the user who has purchased the product to be recommended has purchased this product, whereby the other members are able to obtain information that will help them to make a decision whether or not to purchase the product.

Further, the recommendation information generation unit 150 may generate recommendation information including a usage frequency by or a usage period of a member regarding whom a change in the value of a data item has been detected regarding the services specified by the purchase history extracted by the purchase history extraction unit 140. That is, the recommendation information may include information indicating how often the service to be recommended has been used by a member regarding whom the value of a predetermined data item has been changed. As described above, the usage frequency can be specified based on, for example, the payment data of this member, and the usage period can be specified by, for example, specifying the period during which a service is being provided by using a database or the like. By using this recommendation information, it is possible to notify other members of information indicating how frequently or how long the user who has used the service to be recommended has used this service, whereby the other members are able to obtain information that will help them to make a decision whether or not to purchase the service.

The recommendation information generation unit 150 may generate recommendation information further including information for recommending products or services related to the product or the service specified by the purchase history extracted by the purchase history extraction unit 140. That is, the recommendation information may include, besides the product or the service purchased by a member regarding whom the value of a predetermined data item has been changed, information for recommending products or services related to the above product or service. The recommendation information generation unit 150 searches, for example, a database for storing information that defines products or services related to each product or each service, thereby specifying products or services related to the product or the service purchased by a member regarding whom the value of a predetermined data item has been changed. The products or the services related to one product or service are, for example, but not limited to, products or services similar to the aforementioned product or service. The products or the services related to one product or service may be products or services having some kind of a relation with the aforementioned product or service. By using the recommendation information, not only information on the product or the service that the user has actually purchased but also information on products or services related to the product or the service that the user has actually purchased are sent to other users, which help the other users to make a decision whether or not to purchase various related products or services.

While some information items included in the recommendation information have been described above, the information included in the recommendation information is not limited to the aforementioned information items. The recommendation information may further include, for example, identification information of a buyer of the product or the service to be recommended, that is, identification information of a user who belongs to a group the same as that the user who receives the recommendation information belongs to and regarding whom the value of a predetermined data item has been changed (improved).

The notification unit 160 notifies the other members of the group of the recommendation information generated by the recommendation information generation unit 150. That is, the notification unit 160 notifies other members who belong to a group the same as that to which the member whose purchase history used to generate the recommendation information has been extracted belongs of the recommendation information. Specifically, the notification unit 160 transmits the generated recommendation information to the user terminal device 40 of each of the members. The notification unit 160 may transmit not only the recommendation information but also other information items to the user terminal device 40. The notification unit 160 may notify, for example, each of the members of the group of a configuration of the group, that is, identification information of members forming the group.

The user terminal devices 40 are terminal devices used by the respective users, and each correspond to, for example, but not limited to, a smartphone, a tablet terminal, a personal computer or the like. The user terminal device 40 includes an output device and outputs the recommendation information sent from the recommendation device 10. The output device may be a display or may instead be a speaker. That is, it is sufficient that the output device included in the user terminal device 40 be any device capable of outputting the recommendation information to the user.

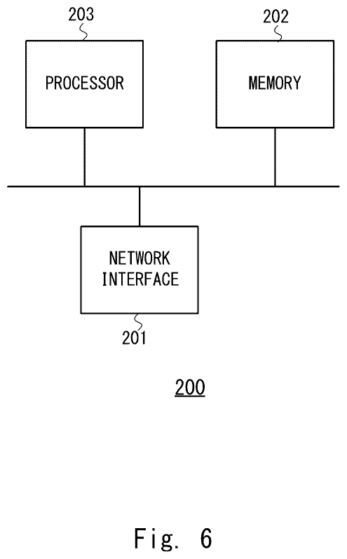

Each of the recommendation device 10, the payment data management device 20, the health data management device 30, and the user terminal device 40 functions as a computer. FIG. 6 is a block diagram showing one example of a configuration of a computer 200 that the recommendation device 10, the payment data management device 20, the health data management device 30, and the user terminal device 40 include. As shown in FIG. 6, the computer 200 includes a network interface 201, a memory 202, and a processor 203.

The network interface 201 is used to communicate with any other device. The network interface 201 may include, for example, a network interface card (NIC).

The memory 202 is composed of, for example, a combination of a volatile memory and a non-volatile memory. The memory 202 is used to store software (computer program) including one or more instructions executed by the processor 203, data used for various kinds of processing and the like.

The processor 203 loads software (computer program) from the memory 202 and executes the loaded software, thereby performing the aforementioned processing of each device. The processor 203 may be, for example, a microprocessor, a Micro Processor Unit (MPU), or a Central Processing Unit (CPU). The processor 203 may include a plurality of processors.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

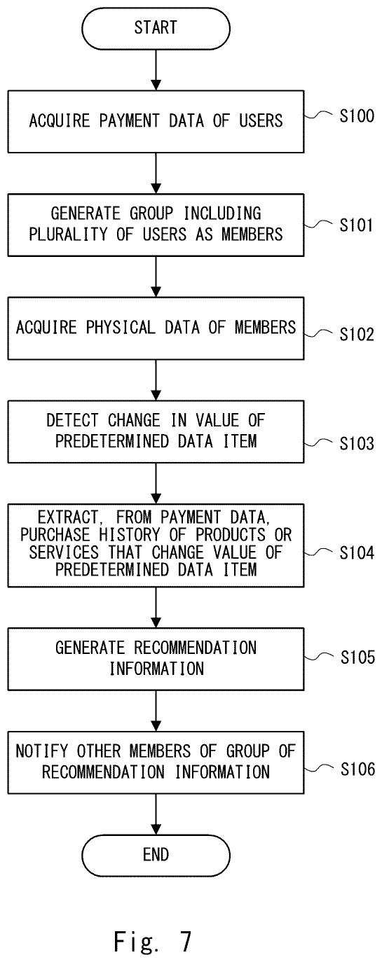

Next, a flow of processing of the recommendation device 10 will be described with reference to a flowchart. FIG. 7 is a flowchart showing one example of a flow of processing of the recommendation device 10. Hereinafter, with reference to FIG. 7, the flow of the processing will be described.

In Step S100, the payment data acquisition unit 100 acquires payment data of various users from the payment data management device 20.

Next, in Step S101, the group generation unit 110 generates a group including a plurality of users as members based on the payment data acquired in Step S100.

Next, in Step S102, the member data acquisition unit 120 acquires physical data of each of the members in the group generated in Step S101 from the health data management device 30. Note that, in this step, the member data acquisition unit 120 may further acquire exercise data of each of the members from the health data management device 30.

Next, in Step S103, the data detection unit 130 detects a change in a value of a predetermined data item in the physical data of each of the members acquired in Step S102.

Next, in Step S104, the purchase history extraction unit 140 extracts, from payment data of the member regarding whom the change in the value of the predetermined data item has been detected in Step S103, the purchase history of products or services that change the value of the predetermined data item.

Next, in Step S105, the recommendation information generation unit 150 generates recommendation information for recommending products or services specified by the purchase history extracted in Step S104.

Lastly, in Step S106, the notification unit 160 transmits the recommendation information generated in Step S105 to user terminal devices 40 of the other members of the group generated in Step S101.

The embodiment has been described above. As described above, the health support system 1 according to this embodiment detects a change in physical data of a member in a group generated based on payment data, generates recommendation information for recommending products or services specified based on the payment data of this member, and notifies the other members of the group of the generated recommendation information. According to the aforementioned health support system 1, it becomes possible to generate a group which is based on the similarity in terms of purchasing tendencies and to recommend effective products or services specified from the purchase history of a member regarding whom the value of a predetermined data item has been improved to the other members of the group. Therefore, the user is able to acquire information regarding effective products or services used by other users regarding whom the user feels a sense of familiarity due to the user belonging to the group including the other users. Therefore, it is possible to make purchasing of a product or a service that supports health appealing to a user more definitely.

The present disclosure is not limited to the aforementioned embodiment and may be changed as appropriate without departing from the spirit of the present disclosure. For example, while the health support system 1 includes, besides the recommendation device 10, the payment data management device 20 that manages the payment data and the health data management device 30 that manages the data regarding health in the aforementioned embodiment, the recommendation device 10 may include functions of these management devices.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A health support system comprising:
a payment data acquisition unit configured to acquire payment data of a user;
a group generation unit configured to generate, based on the payment data, a group including a plurality of the users as members;
a member data acquisition unit configured to acquire physical data of each of the members;
a data detection unit configured to detect a change in a value of a predetermined data item in the physical data;
a purchase history extraction unit configured to extract purchase history of a product or a service that changes the value of the predetermined data item from the payment data of the member regarding whom the change in the value of the predetermined data item has been detected;
a recommendation information generation unit configured to generate recommendation information for recommending the products or services specified by the extracted purchase history; and
a notification unit configured to notify the other members of the group of the generated recommendation information.

2. The health support system according to claim 1, wherein the recommendation information generation unit generates the recommendation information including an amount of change in the value of the predetermined data item.

3. The health support system according to claim 1, wherein the recommendation information generation unit generates the recommendation information including a purchase frequency or a purchase volume by the member regarding whom the change in the value of the predetermined data item has been detected regarding the products specified by the extracted purchase history.

4. The health support system according to claim 1, wherein the recommendation information generation unit generates the recommendation information including a usage frequency by or a usage period of the member regarding whom the change in the value of the predetermined data item has been detected regarding the services specified by the extracted purchase history.

5. The health support system according to claim 1, wherein the recommendation information generation unit generates the recommendation information further including information for recommending products or services related to the products or the services specified by the extracted purchase history.

6. The health support system according to claim 1, wherein
the member data acquisition unit further acquires data of an exercise history of each of the members, and
the recommendation information generation unit generates the recommendation information for recommending, among the products or the services specified by the extracted purchase history, the product or the service selected based on the exercise history of the member regarding whom the change in the value of the predetermined data item has been detected.

7. A health support method comprising:
acquiring payment data of a user;
generating, based on the payment data, a group including a plurality of the users as members;
acquiring physical data of each of the members;
detecting a change in a value of a predetermined data item in the physical data;
extracting purchase history of a product or a service that changes the value of the predetermined data item from the payment data of the member regarding whom the change in the value of the predetermined data item has been detected;
generating recommendation information for recommending the products or services specified by the extracted purchase history; and
notifying the other members of the group of the generated recommendation information.

8. A non-transitory computer readable medium storing a program for causing a computer to execute the following processing of:
acquiring payment data of a user;
generating, based on the payment data, a group including a plurality of the users as members;
acquiring physical data of each of the members;
detecting a change in a value of a predetermined data item in the physical data;
extracting purchase history of a product or a service that changes the value of the predetermined data item from the payment data of the member regarding whom the change in the value of the predetermined data item has been detected;
generating recommendation information for recommending the products or services specified by the extracted purchase history; and
notifying the other members of the group of the generated recommendation information.
